(19) United States
(12) Patent Application Publication
(10) Pub. No.: US 2014/0355065 A1
(43) Pub. Date: Dec. 4, 2014

(54) PRINTER

(71) Applicant: J. Troy Bergstrand, Meridian, ID (US)

(72) Inventor: J. Troy Bergstrand, Meridian, ID (US)

(21) Appl. No.: 14/373,127

(22) PCT Filed: Mar. 26, 2012
(86) PCT No.: PCT/US2012/030594

§ 371 Date: Jul. 18, 2014

(51) Int. Cl. G06F 3/12; G06K 15/00; G06K 15/02

(52) U.S. Cl. CPC G06F 3/1204; G06F 3/1258; G06F 3/1225; G06F 3/1279; G06K 15/1805; G06K 15/4045
USPC 358/1.15

(57) ABSTRACT

A printer includes a processor and a printing mechanism. The printer also includes a non-transitory computer-readable storage medium having instructions that, when executed by the processor, cause the processor to provide a. user-interface to a device. The user-interface includes at least one of the following options to: select document media parameters of the printer, select document print job parameters of the printer, or select print job status. The storage medium also includes instructions that cause the processor to process the selections and a document received from the device for printing. The storage medium further includes instructions that cause the processor to print the document based on selections received from the device. A non-transitory computer-readable storage medium including instructions executable by a printer processor for printing a document sent by a device is also disclosed, as is a method for printing a document sent by a device.

### BACKGROUND

A challenge exists to deliver quality and value to consumers, for example, by providing reliable products that are cost effective. Further, businesses may desire to make their products more user-friendly, for example, by making their products easier to use and update.

### BRIEF DESCRIPTION OF THE DRAWINGS

The following detailed description references the drawings, wherein:

FIG. 1 is a diagram of an example of a printer.

FIG, 2 is a diagram of an example of a device utilizing the printer of FIG. 1.

FIG. 3 is a diagram on another example of a different device utilizing the printer of FIG. 1.

FIG. 4 is a diagram of an example of a select document media parameters user interface,

FIG. 5 is a diagram of an example of a select document print job parameters user interface.

FIG. 6 is a diagram of an example of a select print job status user interface.

FIG. 7 is an example of a method for printing a document sent by a device,

FIG. 8 is an example of additional elements of the method of FIG. 7.

### DETAILED DESCRIPTION

Printers traditionally rely on a driver installed by an end-user of a computer to convert a document from the native imaging format of the operating system of the computer to the page description language (PDL) of the printer. The driver may also implement protocols to transport the PDL to the printer and may additionally support print job status functions.

Oftentimes, an end-user may need to install a different driver on his or her computer for each printer that he or she wants to use. This can be time consuming and difficult for some end-users. Additionally, the software of one or more of such drivers may need to be periodically updated by the end-user which also sometimes can be time consuming and difficult.

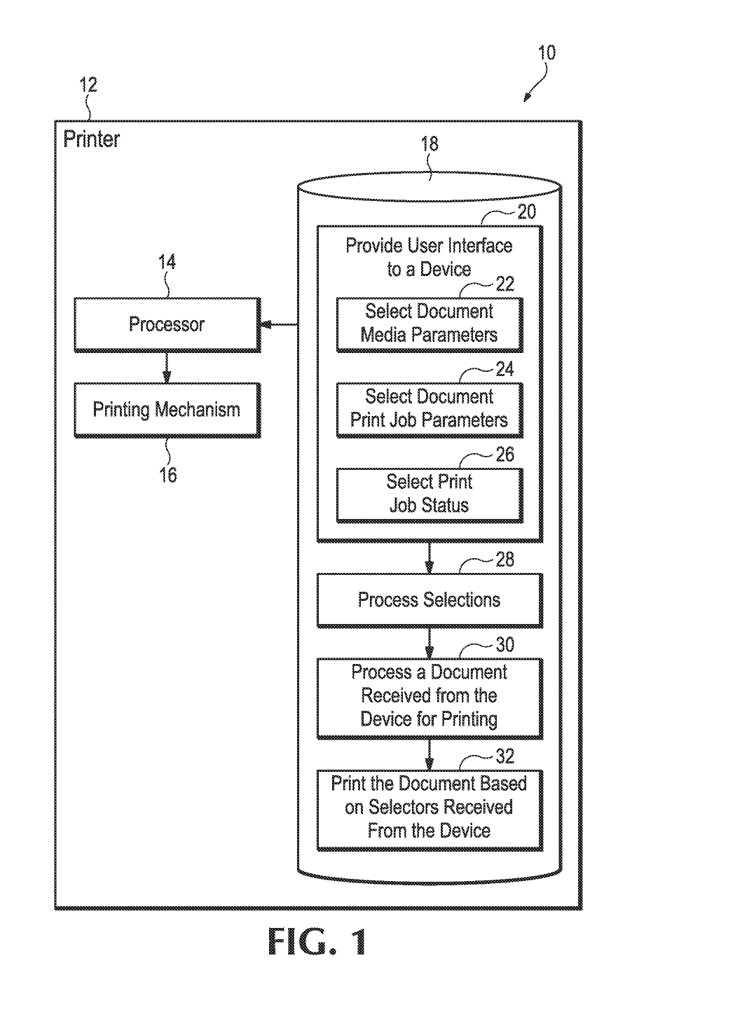

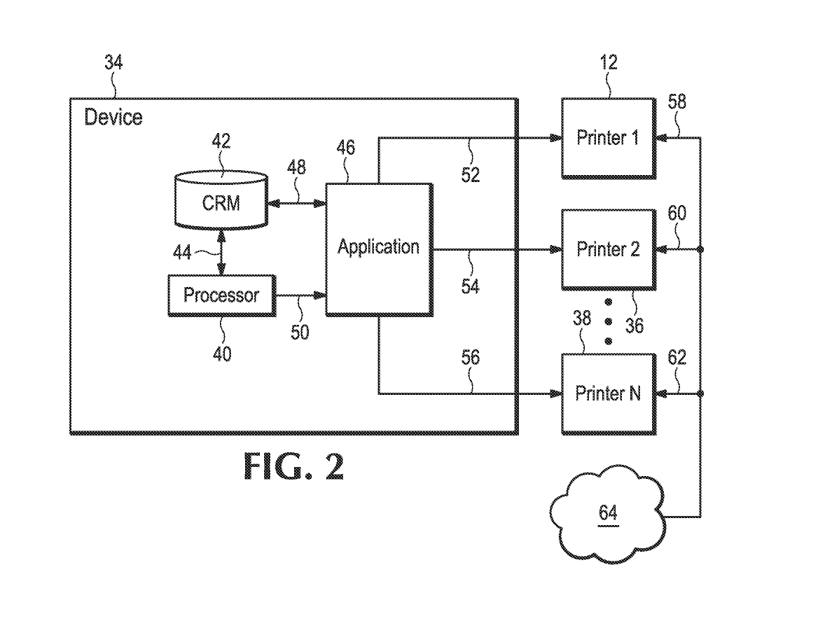

A diagram 10 of an example of a printer 12 that addresses these issues is shown in FIG. 1. As can be seen in FIG. 1, printer 12 includes a processor 14 and a printing mechanism 16 coupled to processor 14 and controlled thereby. Printing mechanism 16 can include a variety of different types of marking technologies including, without limitation, laser jet, ink jet, dot matrix, impact, dye sublimation, and offset printing. Printing mechanism 16 also includes all other necessary components for printing such as media transport, printing supplies, formatter electronics, serving elements, etc. Printer 12 additionally includes a non-transitory computer-readable storage medium 18 that includes or stores instructions executable by processor 14 of printer 12 for printing a document. This document can include text, images, graphics, photos, drawings, spreadsheets, formulas, etc. or a combination of one or more of these items.

As can be seen by block 20 in FIG. 1, when these instructions on non-transitory computer-readable storage medium 18 are executed by processor 14, a user interface relating to printer 12 is presented to a device, the end-user of which desires to print a document. The device can include a variety of items such as a computer, tablet, a mobile phone, a personal digital assistant (PDA), a camera, etc. The device in turn provides the user interface to the end-user for selection of one or more items. In the example shown in FIG. 1, the presented user interface 20 may include one or more of the operations of selecting document media parameters 22, selecting document print job parameters 24, or selecting print job status 26.

The select document media parameters user interface 22 provides options to the end-user regarding selection of a media size for document (e.g. 8.5″×11″, A4, etc.), and a media type (plain, gloss, matte, etc.). The select document print job parameters user interface 24 provides options to the end-user regarding selection of items such as the number of copies, print resolution, duplex or simplex printing, margins, color or monochrome printing, stapling, collating, etc. The select print job status user interface 26 provides information to the end-user regarding items such as job cost, occurrence of media jams, location of media jams, consumable supply levels, extent of job remaining until completion, etc., thereby allowing end-user 98 to track the status of a print job and respond to any issues.

The instructions on non-transitory computer-readable storage medium 18 executed by processor 14 next process the selections made by the end-user of the device via one or more of user interfaces 22, 24, and 26, as indicated by block 28 in FIG. 1. As can additionally be seen in FIG. 1, processor 14 uses these instructions to also process a document received from the device or printing, as indicated by block 30. This can include converting the document to the PDL of the printer. Finally, processor 14 utilizes the instructions on non-transitory computer-readable storage medium 18 to control printing mechanism 16 to print the document based on the selections received from the device, as indicated by block 32 in FIG. 1.

A diagram of an example of a device 34 that utilizes printer 12 is shown in FIG. 2. Device 34 may also utilize one or more additional printers 36 through 38, each of which includes a processor, printing mechanism, and non-transitory computer-readable storage medium storing instructions executable by the processor of the nature discussed above in connection with FIG. 1. As discussed above, device 34 can include a variety of items such as a computer, tablet, a mobile phone, a personal digital assistant (PDA), a camera, etc. As can be seen in FIG. 2, device 34 includes a processor 40 and a non-transitory computer-readable storage medium (CRM) 42 that stores instructions executable by processor 40, as indicated by double-headed arrow 44. As can also be seen in FIG. 2, device 34 additionally includes an application 46 that a end-user of device 34 may interact with during use of device 34, For example, device 34 may be a mobile phone and application 46 may include photo-capture, cataloguing and printing software. Application 46 may be stored on non-transitory computer-readable medium 42 and may utilize and store data on non--transitory computer-readable storage medium 42 during use, as indicated by double-headed arrow 48 in FIG. 2. Processor 40 controls application 46 during its use, as indicated by arrow 50.

At some point during use of device 34, an end-user of application 46 may desire to print documents on one or more of printers 12 or 36-38. Selection of a specific printer may be based on a variety of factors such as the type of document that needs to be printed (i.e., photos) as well as the particular capabilities of printers 12 and 36-38 (e.g., laser jet versus ink jet photo printer). As part of this printing process, application 46 establishes a connection with each printer 12 and 36-38, as indicated by respective arrows 52-56, confirming availability. Upon selection of a particular one of available printers 12 and 36-38 by the end-user, application 46 then obtains a user interface to present to the end-user as discussed above in connection with FIG. 1 and as also discussed in more detail below.

As can be seen in FIG. 2, no drivers are present on device 34 for any of printers 12 or 36-38. This eliminates the need for an end-user of device 34 to install a different driver on device 34 for each of printers 12 and 36-38. Such installation can be time consuming and difficult for some end-users. Additionally, the software of one or more of such drivers may need to be periodically updated or otherwise modified by the end-user which also sometimes can be time consuming and difficult. Instead, each of printers 12 and 36-38 includes a respective connection, as indicated by arrows 58-62, to an external source 64 (e.g., intranet) that allows the instructions on its non-transitory computer-readable storage medium to be updated or otherwise modified independent of interaction with device 34.

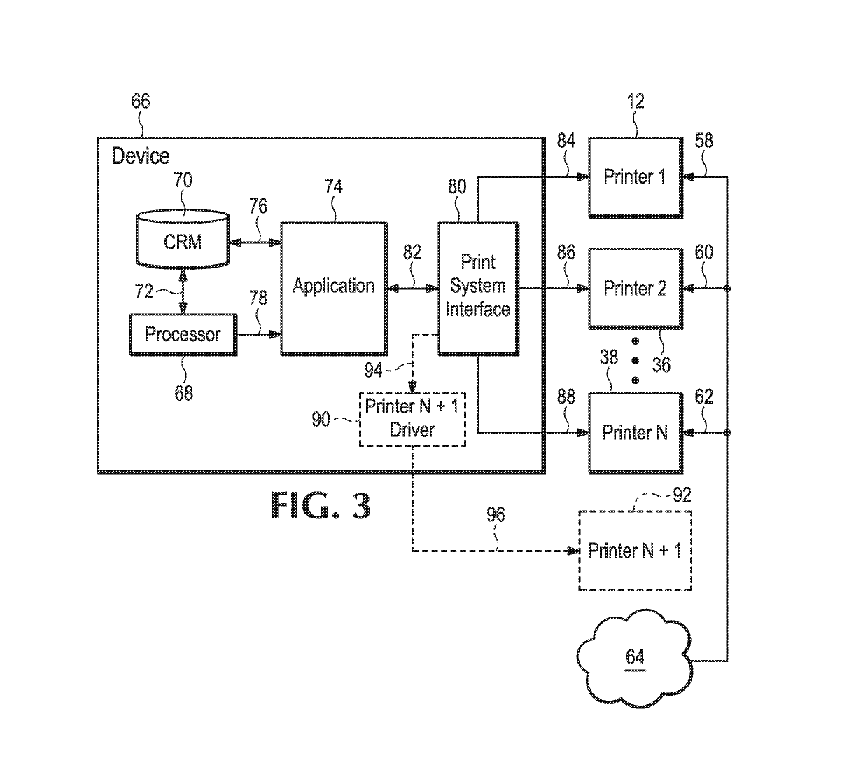

A diagram of another example of a different device 66 that utilizes printer 12 is shown in FIG. 3. Device 66 may also utilize on or more additional printers 36 through 38, each of which includes a processor, printing mechanism, and non-transitory computer-readable storage medium storing instructions executable by the processor of the nature discussed above in connection with FIG. 1. As discussed above, device 66 can include a variety of items such as a computer, tablet, a mobile phone, a personal digital assistant (PDA), a camera, etc. As can be seen in FIG. 3, device 66 includes a processor 68 and a non-transitory computer-readable storage medium (CRM) 70 that stores instructions executable by processor 68, as indicated by double-headed arrow 72. As can also be seen in FIG. 3, device 66 additionally includes an application 74 that an end-user of device 66 may interact with during use of device 66. For example, device 66 may be a computer and application 74 may be a word processor. Application 74 may be stored on non-transitory computer-readable medium 70 and may utilize and store data on non-transitory computer-readable storage medium 70 during use, as indicated by double-headed arrow 76 in FIG. 3. Processor 68 controls application 74 during its use, as indicated by arrow 78.

At some point during use of device 66, an end-user of application 74 may desire to print documents on one or more of printers 12 or 36-38. Selection of a specific printer may be based on a variety of factors such as the type of document that needs to be printed (e.g., text versus image) as well as the particular capabilities of printers 12 and 36-38 (e.g., laser jet versus ink jet). As part of this printing process, application 74 establishes a connection with a print system interface 80, as indicated by double-headed arrow 82. Use of print system interface 80, eliminates the need for application developers to include functionality for interfacing with external printers which can save time, money and complexity during application 74 development. Instead, print system interface 80 establishes a connection with each printer 12 and 36-38, as indicated by respective arrows 84-88, confirming availability. Print system interface 80 in turn passes this information on to application 74 which in turn presents this information to an end-user of device 66. Upon selection of a particular one of available printers 12 and 36-38 by the end-user, application 66 then obtains a user interface to present to the end-user via print system interface 80, as discussed above in connection with FIG. 1 and as also discussed in more detail below.

As can be seen in FIG. 3, no drivers are present on device 66 for any of printers 12 or 36-38. As discussed above, this eliminates the need for an end-user of device 66 to install a different driver on device 66 for each of printers 12 and 36-38. Such installation can be time consuming and difficult for some end-users. As additionally discussed above, the software of one or more of such drivers may need to be periodically updated or otherwise modified by the end-user which also can sometimes be time consuming and difficult. Instead, each of printers 12 and 36-38 includes a respective connection, as indicated by arrows 58-62, to an external source 64 (e.g., intranet) that allows the instructions on its non-transitory computer-readable storage medium to be updated or otherwise modified independent of interaction with device 66.

An additional feature of print system interface 80 is the enablement of the use of traditional drivers by device 66, such as printer N+1 driver 90, and other printers, such as printer N+1 92, that do not include a processor, printing mechanism, and non-transitory computer-readable storage medium storing instructions executable by the processor of the nature discussed above in connection with FIG. 1. As can be seen in FIG. 3, print system interface 80 provides data to driver 90, as indicated by arrow 94, which in turn both controls and provides data to printer 92, as indicated by arrow 96. The use by device 66 of additional of printer drivers and associated printers, such as driver 90 and printer 92, is independent of and in addition to the use of printers 12 and 36-38, as discussed above. This provides end-users of device 66 with additionally flexibility and options that may not necessary be available or otherwise provided.

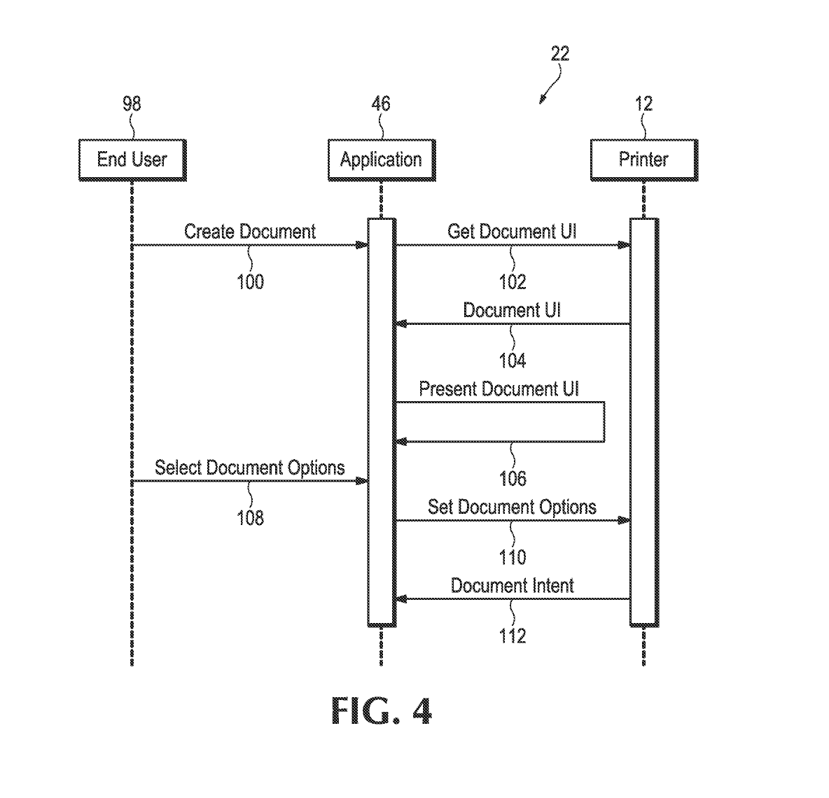

A diagram of an example of interaction between printer 12, application 46, and an end-user 98 of device 34 is shown in FIG, 4 for the select document media parameters 22 user interface discussed above in connection with FIG. 1. As can be seen in FIG. 4, end-user 98 has created a document through the use of application 46 that end-user 98 now wants to print, as indicated by “Create Document” arrow 100. Application 46 transmits a request to printer 12 for printer 12 to provide a. document user-interface, as indicated by “Get Document UI” arrow 102. Printer 12 processes this request and returns the document user-interface to application 46, as indicated by “Document UI” arrow 104. Application 46 in turn presents the document user-interface of printer 12 to end-user 98 and waits for end-user 98 to select various options relating to media size for the document (e.g., 8.5″×11″, A4, etc.), and media type (plain, gloss, matte, etc.), as indicated by “Present Document UI” arrow 106. The options selected by end-user 98 via the document user-interface are recorded by application 46, as indicated by “Select Document Options” arrow 108, and then transmitted to printer 12 for processing, as indicated by “Set Document Options” arrow 110. Printer 12 acknowledges receipt and processing of the selected document options to application 46, as indicated by “Document Intent” arrow 112.

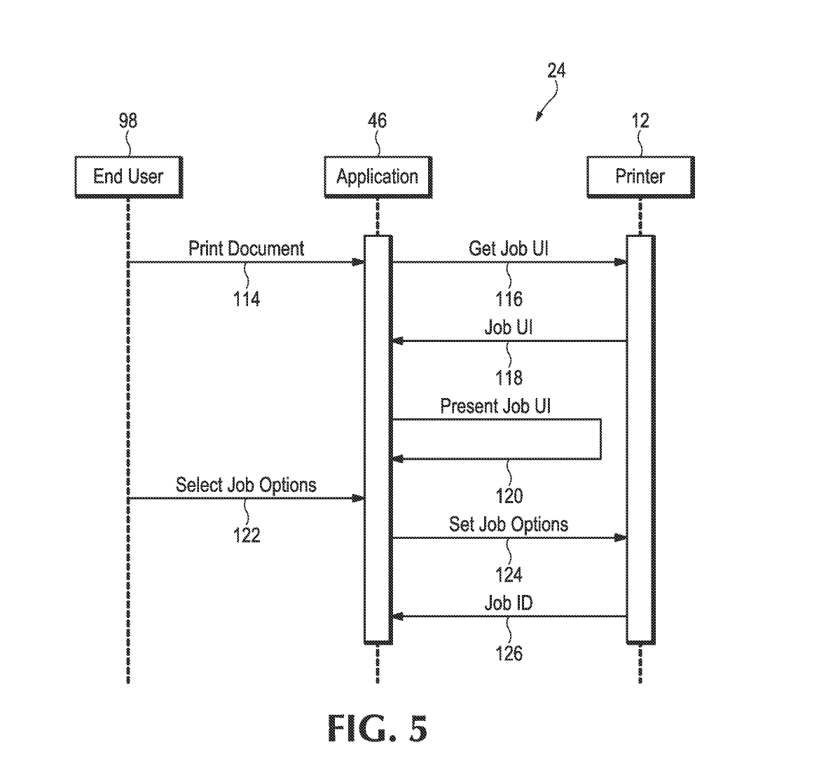

A diagram of an example of interaction between printer application 46, and an end-user 98 of device 34 is shown in FIG. 5 for the select document print job parameters 24 user interface discussed above in connection with FIG. 1. As can be seen in FIG. 5, end-user 98 now wants to print the document and issues a print command to application 46, as indicated by “Print Document” arrow 114. Application 46 transmits a. request to printer 12 for printer 12 to provide a job user-interface, as indicated by “Get Job UI” arrow 116. Printer 12 processes this request and returns the job user-interface to application 46, as indicated by “Job UI” arrow 118. Application 46 in turn presents the job user-interface of printer 12 to end-user 98 and waits for end-user 98 to select various options regarding selection of items such as the number of copies, print resolution, duplex or simplex printing, margins, color or monochrome printing, stapling, collating, etc., as indicated by “Present Job UI” arrow 120. The options selected by end-user 98 via the job user-interface are recorded by application 46, as indicated by “Select Job Options” arrow 122, and then transmitted to printer 12 for processing, as indicated by “Set Job Options” arrow 124, Printer 12 acknowledges receipt and processing of the selected job options to application 46 by providing a print job identifier, as indicated by “Job ID” arrow 126.

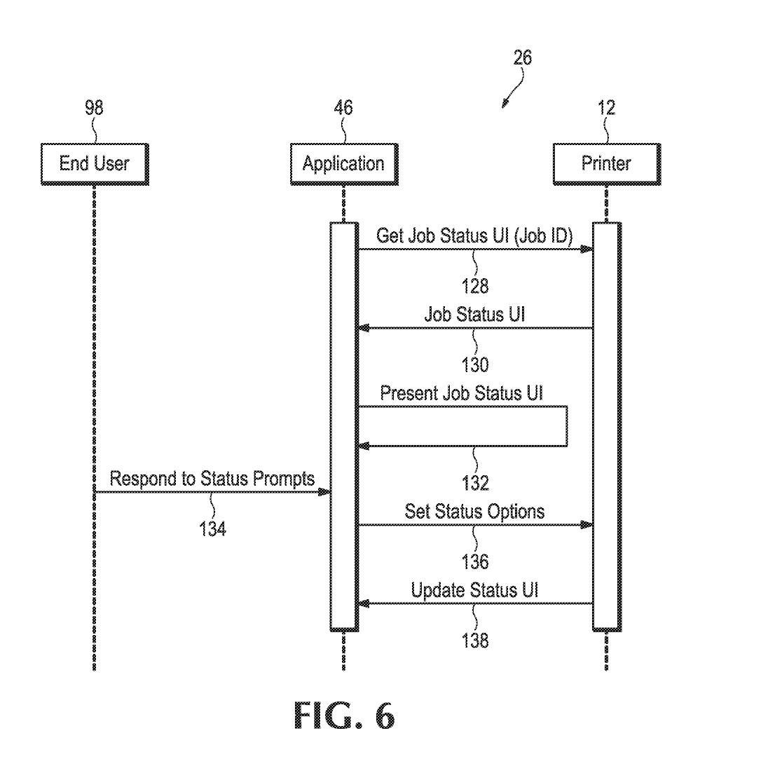

A diagram of an example of interaction between printer 12, application 46, and an end-user 98 of device 34 is shown in FIG. 6 for the select print job status 26 user interface discussed above in connection with FIG. 1. As can be seen in FIG. 6, application 46 requests the job status user-interface from printer 12 by including the job identifier previously provided by printer 12, as indicated by “GET Job Status UI (Job ID)” arrow 128. The print job status user interface 26 provides information application 46 and end-user 98 regarding items such as job cost, occurrence of media jams, location of media jams, consumable supply levels, extent of job remaining until completion, etc., thereby allowing end-user 98 to track the status of a print job and respond to any issues. Printer 12 processes this request and returns the job status user-interface to application 46, as indicated by “Job Status UI” arrow 130. Application 46 in turn presents the job status user-interface of printer 12 to end-user 98 and waits for end-user 98 to respond to any prompts (e.g., input media tray empty, load additional print media), as indicated by “Present Job UI” arrow 132. Once end-user 98 responds, as indicated by “Respond to Status Prompts” arrow 134 or after a predetermined period of time if no response on the part of end-user 98 is required, application 46 transmits this information to printer 12 for processing or requests a job status update, as indicated by “Set Status Options” arrow 136. Printer 12 acknowledges receipt and processing of this information or request by providing an update to the job status user-interface to application 46, as indicated by “Update Status UI” arrow 138.

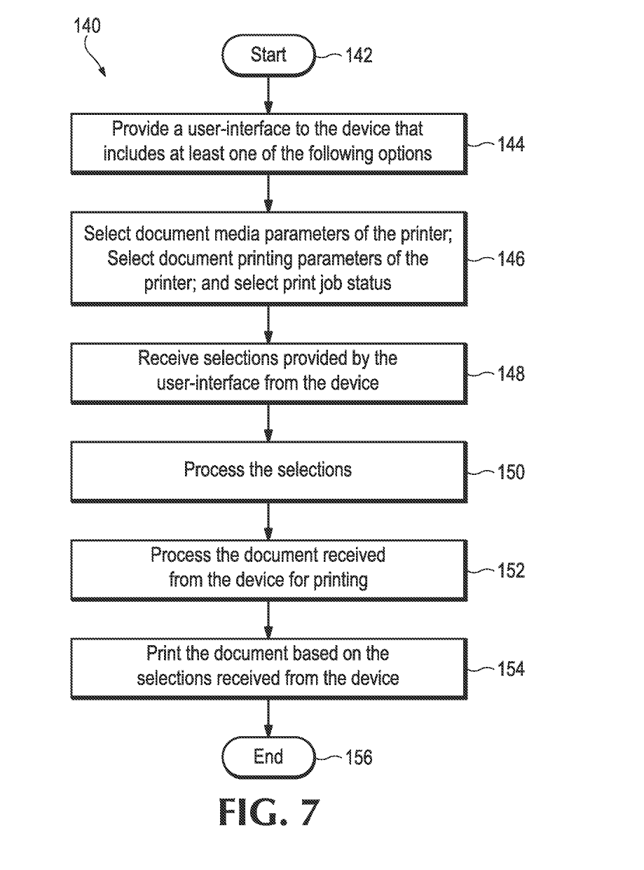

A diagram of an example of a method 140 for printing a document sent by a device (e.g., device 34 or 66) is shown in FIG. 7. As can be seen in FIG. 7, method 140 starts, as indicated by block 142, by providing a user-interface to the device that includes at least one of the following options, as indicated by block 144: select document media parameters of the printer, select document printing parameters of the printer, or select print job status as indicated by Hock 146. Next, method 140 receives the selections provided by the user-interface from the device, as indicated by block 148, and then processes the selections, as indicated by block 150. Method 140 then processes the document received from the device for printing, as indicated by block 152, and then prints the document based on the selections received from the device, as indicated by block 154. Method 140 may then end 156.

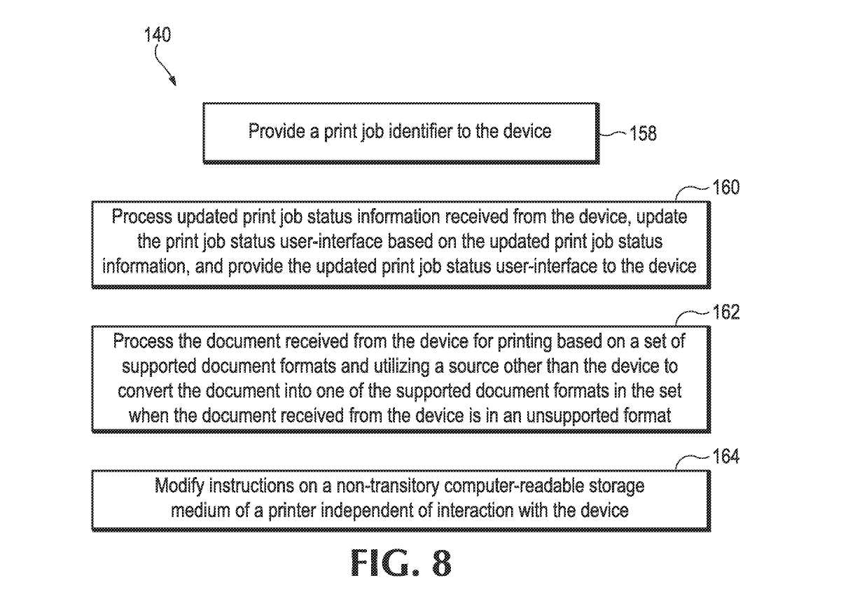

Examples of additional elements of method 140 are shown in FIG. 8. As can be seen in FIG. 8, method 140 may provide a print job identifier to the device, as generally indicated by block 158. Additionally or alternatively, method 140 may process updated print job status information received from the device, update the print job status user-interface based on the updated print job status information, and provide the updated print job status user-interface to the device, as indicated by block 160. Method 140 may also process the document received from the device for printing based on a set of supported document formats and utilize a source other than the device (e.g., via connection to external source 64) to convert the document into one of the supported document formats in the set when the document received from the device is in an unsupported format, as indicated by block 162. Method 140 may further modify instructions on a non-transitory computer-readable storage medium of a printer independent of interaction with the device, as indicated by block 164.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, more than one application may interact with print system interface 80, rather than just application 74. As another example, print system interface 80 can be used in between application 46 and printer 12 in FIGS. 4-6 for device 34 to provide the additional benefits discussed above in connection with FIG. 3. The spirit and scope of the present invention are to be limited only by the terms of the following claims,

Additionally, reference to an element in the singular is not intended to mean one and only one, unless explicitly so stated, but rather means cans one or more. Moreover, no element or component is intended to be dedicated to the public regardless of whether the element or component is explicitly recited in the following claims.

What is claimed is:

1. A printer, comprising:
a processor;
a printing mechanism coupled to the processor and controlled thereby; and
a non-transitory computer-readable storage medium including instructions that, when executed by the processor, cause the processor to:
provide a user-interface to a device that includes at least one of the following options to:
select document media parameters of the printer;
select document print job parameters of the printer, and
select print job status;
process selections;
process a document received from the device for printing; and
print the document based on the selections received from the device.

2. The printer of claim 1, wherein the non-transitory computer-readable storage medium further includes instructions that, when executed by the processor, cause the processor to provide a print job identifier to the device

3. printer of claim 1, wherein upon selection of print job status and processing of the selections, the on-transitory computer-readable storage medium further includes instructions that, when executed by the processor, cause the processor to process updated print job status information received from the device, update the print job status user-interface based on the updated job status information, and provide the updated print job status user-interface to the device.

4. The printer of claim 1, wherein the non-transitory computer-readable storage medium includes instructions that, when executed by the processor, cause the processor to process the document received from the device for printing based on a set of supported document formats, and further wherein the non-transitory computer-readable storage medium further includes instructions that, when executed by the processor, cause the processor to utilize a source other than the device to convert the document into one of the supported document formats in the set when the document received from the device is in an unsupported format.

5. The printer of claim 1, wherein the instructions on the non-transitory computer-readable storage medium are modifiable independent of interaction with the device,

6. A non-transitory computer-readable storage medium including instructions executable by a processor of a printer for printing a document sent by a device, the non-transitory computer-readable storage medium, comprising:
instructions for providing a user-interface to the device that includes at least one of the following options to:
select document media parameters of the printer,
select document printing parameters of the printer, and
select print job status;
instructions for processing selections received from the device;
instructions for processing the document received from the device for printing; and
instructions for printing the document based on the selections received from the device.

7. The non-transitory computer-readable storage medium of claim 6, further comprising instructions for providing a print job identifier to the device.

8. The non-transitory computer-readable storage medium of claim 6, further comprising instructions for processing updated print job status information received from the device, instructions for updating the print job status user-interface based on the updated print job status information, and instructions for providing the updated print job status user-interface to the device.

9. The non-transitory computer-readable storage medium of claim 6, further comprising instructions for processing the document received from the device for printing based on a set of supported document formats and instructions for utilizing a source other than the device to convert the document into one of the supported document formats in the set when the document received from the device is in an unsupported format.

10. non-transitory computer-readable storage medium of claim 6, wherein the instructions on the non-transitory computer-readable storage medium are modifiable independent of interaction with the device.

11. A method for printing a document sent by a device, comprising:
providing a user-interface to the device that includes at least one of the following options to:
select document media parameters of the printer,
select document printing parameters of the printer, and
select print job status;
receiving selections provided by the user-interface from the device;
processing the selections;
processing the document received from the device or printing; and
printing the document based on the selections received from the device.

12. The method of claim 11, further comprising providing a print job identifier to the device.

13. The method of claim 11, further comprising processing updated print job status information received from the device, updating the print job status user-interface based on the updated print job status information, and providing the updated print job status user-interface to the device.

14. The method of claim 11, further comprising processing the document received from the device for printing based on a set of supported document formats and utilizing a source other than the device to convert the document into one of the supported document formats in the set when the document received from the device is in an unsupported format,

15. The method of claim 11, further comprising modifying instructions on a non-transitory computer-readable storage medium of a printer independent of interaction with the device.
